(19) United States
(12) Patent Application Publication
(10) Pub. No.: US 2018/0306725 A1
(43) Pub. Date: Oct. 25, 2018

(54) DYNAMIC COLOR FILTER MACROSCOPIC INSPECTION SYSTEM AND METHOD

(71) Applicants: HKC Corporation Limited, Shenzhen City, Guangdong (CN); Chongqing HKC Optoelectronics Technology Co., Limited, Chongqing (CN)

(72) Inventor: Houyi ZHU, Chongqing (CN)

(21) Appl. No.: 15/578,625

(22) PCT Filed: May 23, 2017
(86) PCT No.: PCT/CN2017/085558

§ 371 Date: Nov. 30, 2017

(30) Foreign Application Priority Data
Dec. 29, 2016 (CN) 201611242996.2

(51) Int. Cl. G01N 21/84; C03C 17/00; G01J 3/46

(52) U.S. Cl. CPC G01N 21/8422; C03C 17/002; G01N 2021/845; C03C 2217/70; G01N 2021/8427; G01J 3/46

(57) ABSTRACT

This application provides a dynamic color filter (CF) macroscopic inspection system and method. The dynamic CF macroscopic inspection system includes: a color film coating unit, configured to coat color filters on a CF glass substrate; a color film developing unit, configured to develop the CF glass substrate; a color film baking unit, configured to bake the CF glass substrate; a color film macroscopic inspection unit, configured to inspect a visual macroscopic abnormality of the CF glass substrate; a color film colorimeter unit, configured to perform a chrominance detection on the CF glass substrate; and at least one conveyor belt, including a first conveyor belt and a second conveyor belt, connected between the color film coating unit, the color film developing unit, the color film baking unit, the color film macroscopic inspection unit, and the color film colorimeter unit, and configured to transport the CF glass substrate.

### BACKGROUND

### Technical Field

This application relates to a dynamic color filter (CF) macroscopic inspection system and method, which are mainly used to inspect a visual macroscopic abnormality of a CF substrate used in a display, including color mura, back scraping, back pollution, film surface scratches, smudges, bright dots, or dark dots of the CF.

### Related Art

A key factor for a thin film transistor liquid crystal display (TFT-LCD) to display color images is a CF. The CF is coated, with pigment photoresists of three colors, that is, red, green, and blue. After a light source passes through the CF, red, green, and blue lights are instantly formed, and are finally mixed to form color images in human eyes. The CF is mainly formed through several processes such as photoresist coating, prebaking, exposing, developing, and baking. However, due to parameter setting errors in the processes, faults occurring in a mechanical device, operation abnormalities of the mechanical device, or even dust and scurf in the air, the CF may have defects, including mars, back scraping, back pollution, film surface scratches, smudges, bright dots, dark dots, and the like. Types and sizes of defects on the CF may affect results of the CF, for example, whether it is determined that detection on the CF succeeds, whether the CF requires repair, or even whether the CF is discarded. If defect detection is not well performed and a progress of a subsequent process is affected, or quality control on delivery of products is poor, costs of producers may increase, and negative impacts may be caused to the company goodwill. Therefore, defect detection in a process of manufacturing CFs is a necessary and important step for reducing cost and improving market competitiveness of the producers. Defect detection for the CF may be divided into two categories, that is, micro defect detection and macroscopic defect detection. The micro defects mainly are defects that are relatively not obvious or not easy to be observed by human eyes and that need to be detected by means of microscope lens. The macroscopic defects mainly are relatively large regions or relatively obvious defects. Defect detection of the CF is mainly performed by means of manual detection. However, persons skilled in the art have different levels for determining types of the defects. After a period of visual inspection, persons skilled in the art may have slower detection speeds due to eyestrain and physiological fatigue, or even determining errors may occur. Therefore, in recent years, automatic detection systems gradually develop, and gradually replace manual identification, so that production efficiency is improved and manpower costs are reduced. It is expected in this application, by means of a macroscopic inspection system for a CF, macroscopic defect detection and defect type classification can be achieved, so as to facilitate subsequent processing of persons skilled in the art. A main objective is to effectively accelerate a defect detection speed and improve market competitiveness of producers by means of the macroscopic inspection, system for the CF.

Compared with sizes of micro defects, macroscopic defects are relatively large and can be identified by human eyes. Defects that are not easy to be observed by human eyes in the CF include: white defects, black defects, transparent electrode film defects, film surface damages, metal residues, filter layer defects, bad etching of chromium (Cr), glass bubbles, foreign body residues, mura, back scraping, back pollution, film surface scratches, smudges, bright dots. dark dots, and the like.

Macroscopic inspection is to check, at different orientations and angles by using different light sources, whether a piece of glass has mura, scratches, film smudges, and the like. When the glass is detected, specialists determine non defective products and defective products according to defect specifications. Especially in subsequent inspection of a finished product/semi-finished product of a panel, a mum phenomenon due to mura of a to-be-detected CF may be often found. A common mum phenomenon may be divided into various defects such as cloud antra and line mura. The defects severely affect visual feelings of a user, and therefore, are an important basis for determining, quality of a liquid crystal display. Currently, relevant inspection mechanisms, after photoresist coating and before developing, developed in the industry of CFs such as Sampling Na Macroscopy, Auto-Thickness Measure, and Virtual Image Check are only limited to inspection of macroscopic defects before developing. For a period after developing to before finishing of CFs, inspection of macroscopic defects of terminals cannot provide effective helps.

Currently, in the industry of CFs, inspection of macroscopic defects of terminals is performed by means of light transmission. A to-be-detected CF is located between a light source and an inspector, and is configured with various photoresists such as a red photoresist, a green photoresist, a blue photoresist, and a black matrix. The inspector observes, in a visual manner, a light ray passing from the light source through the to-be-detected CF, and inspects whether there are macroscopic defects. However, during a process of manufacturing the to-be-detected CF, mura inspection needs to be performed on a developed finished product/semi-finished product, and it is very difficult to determine mura only with eyes. Therefore, by means of the foregoing inspection, macroscopic defects cannot be effectively inspected.

In addition, in the past, when CFs are finished in small sheets, a method of inspecting by using a shutter is used to confirm whether three colors, that is, R/G/B, have color mura, and the effect is good. However, after the CFs are finished in full sheets and a negative resin black matrix is introduced, due to difficulties in jig manufacturing and processing, the method cannot be applied, and a capability of macroscopic defect inspection is low when the CFs are finished.

The shutter is disposed between the light source and the to-be-detected CF. A shading region corresponds to the red photoresist and the blue photoresist of the CF, and a transparent region corresponds to the green photoresist. Therefore, by means of functions of the shutter and the to-be-detected CF, a white light emitted by the light source can be converted into a green light. According to a status of the filtered green light, that is, a single green picture, which facilitates inspection of macroscopic defects, the inspector can determine whether there is a green mura problem. Similarly, if a red or blue picture is to be inspected, the to-be-detected CF or the shutter only needs to be moved to the left or right by one sub-pixel, so that the transparent region corresponds to the red photoresist or the blue photoresist. After inspection of an R/G/B single color picture is completed, comprehensive determining of a macroscopic defect of mura can be performed.

In conclusion, an improvement object and method of a color film macroscopic inspection unit of a CF is still needed, so as to improve production efficiency, a yield, and quality of a liquid crystal display panel.

### SUMMARY

To resolve the foregoing technical problem and to rapidly detect macroscopic defects in different phases of a process, an objective of this application is to provide a method for inspecting a to-be-detected CF, so that different targeted inspections are provided for different phases of the process. This application relates to a CF macroscopic inspection, machine, and the CF macroscopic inspection machine is an important inspection device in a process of manufacturing CFs in the TFT-LCD industry. The CF macroscopic inspection machine is mainly used to inspect a visual macroscopic abnormality of a CF substrate, including mura (mura of developing brightness), back scraping, back pollution, film surface scratches, smudges, bright dots, dark dots, or the like. In a CF production line process, an apparatus is designed for the CF macroscopic inspection machine in a main production line, so that different targeted inspections are provided for different phases of the process.

Features of this application are as follows: (1) A color film macroscopic inspection unit is placed after a coater and before an exposure machine, and cooperates with a color film colorimeter device, so as to mainly detect a film thickness abnormality that is generated after coating. An advantage is that an abnormality that occurs after coating may be found in time, and the abnormality may be processed and mura (mura of developing brightness) detected by the color film colorimeter may be confirmed in a subsequent process. A disadvantage is that the detected abnormality may be a false abnormality. (2) The color film macroscopic inspection unit is placed after the exposure machine, and before a developer, so as to mainly detect an abnormality that is generated after coating and exposure. An advantage is that the abnormality that occurs after coating and exposure may be found in time, and the abnormality may be processed and some false abnormalities may be eliminated in the subsequent process. A disadvantage is that the color film macroscopic inspection unit does not well cooperate with the color film colorimeter. (3) The color film macroscopic inspection unit is placed after the developer and before an oven, so as to mainly detect an abnormality that occurs after developing. An advantage is that the abnormality that occurs after developing may be found in time, and the abnormality may be subsequently processed. A defect is that the color film macroscopic inspection unit cannot cooperate with the color film colorimeter, a detection frequency and an interception capability are limited, and a process for processing an abnormal product is complex. (4) The color film macroscopic inspection unit is placed after the oven, to detect a CF after all processes are completed. An advantage is that the detection is accurate and a false abnormality can be excluded to a maximum limit. A defect is that subsequent processing cannot be performed after an abnormality is detected, and reworking needs to be performed. A great loss is caused when an abnormality occurs. In addition, benefits of this application further include implementation of four main inspection designs: normal random inspection on a glass substrate after coating; normal random inspection on a glass substrate after exposure; cooperating with the color film colorimeter and re-determining an abnormal glass substrate detected by the color film colorimeter; and macroscopic inspection on a foreign body detected by a color film protrusion inspection machine, so that no additional coverage area needs to be added, to reduce costs.

The following technical measures may be used to further achieve the objective of this application and resolve the technical problem of this application.

Another objective of this application is to provide a dynamic CF macroscopic inspection system, comprising, a color film coating unit, configured to coat color filters on a CF glass substrate; a color film developing unit, configured to develop the CF glass substrate; a color film baking unit, configured to bake the CF glass substrate; a color film macroscopic inspection unit, configured to inspect a visual macroscopic abnormality of the CF glass substrate; a color film colorimeter unit, configured to perform a chrominance detection on the CF glass substrate; and at least one conveyor belt, comprising a first conveyor belt and a second conveyor belt, connected between the color film coating unit, the color film developing unit, the color film baking unit, the color film macroscopic inspection unit, and the color film colorimeter unit, and configured to transport the CF glass substrate.

In an embodiment of this application, a shutter needs to be added to the color film macroscopic inspection unit, and a shutter is added to an appropriate position above or below a shutter of an original transmission channel of the color film macroscopic inspection unit; a platform height needs to be adjusted according to a unit sent by a signal on software so as to accept the glass substrate.

In an embodiment of this application, a conveyor belt needs to be added outside the color film macroscopic inspection unit based on the original conveyor belt, and only one conveyor belt is added above the original conveyor belt according to a status of the transmission channel.

In an embodiment of this application, the dynamic CF macroscopic inspection system further comprises an exposure machine unit, connected to the conveyor belt, and configured to expose the CF glass substrate.

In an embodiment of this application, the conveyor belt is adjusted to implement a plurality of inspection applications for the CF glass substrate before exposure and the CF glass substrate after exposure, in combination with a detection result of the color film colorimeter unit.

In an embodiment of this application, the color film macroscopic inspection unit further comprises two shutters for the CF glass substrate to get in and out, and these shutters are respectively connected to the first conveyor belt and the second conveyor belt; a unit adjustment platform of the color film macroscopic inspection unit is a movable platform.

In an embodiment of this application, the CF glass substrate that is not exposed or the CF glass substrate that is detected and marked by the color film colorimeter enters the color film macroscopic inspection unit from the second conveyor belt.

In an embodiment of this application, the CF glass substrate after exposure enters the color film macroscopic inspection unit from the first conveyor belt, and the CF glass substrate leaves from the second conveyor belt.

A still another objective of this application is to provide a dynamic CF macroscopic inspection method, comprising: placing a CF glass substrate on a conveyor belt; performing normal random inspection on the CF glass substrate that passes through a color film coating unit; performing normal random inspection on the CF glass substrate that passes through an exposure machine unit; cooperating with a color film colorimeter unit, and re-determining an abnormal CF glass substrate detected by the color film colorimeter unit; and inspecting, in a color film macroscopic inspection unit, a foreign body detected by a color film protrusion inspection machine, where the conveyor belt comprises a first conveyor belt and a second conveyor belt and is configured to transport the CF glass substrate.

In an embodiment of this application, the CF glass substrate enters, from the second conveyor belt, the color film macroscopic inspection unit for inspection.

In an embodiment of this application, the CF glass substrate bypasses the color film macroscopic inspection unit and directly enters the exposure machine unit.

In an embodiment of this application, the CF glass substrate bypasses the color film macroscopic inspection unit and the exposure machine unit.

In an embodiment of this application, the CF glass substrate enters, from the first conveyor belt after passing through the exposure machine unit, the color film macroscopic inspection unit for inspection.

In an embodiment of this application, these CF glass substrate leaves from the second conveyor belt after passing through the exposure machine unit.

In an embodiment of this application, macroscopic inspection is performed after coating and before an exposure machine, and is performed by cooperating with a color film colorimeter device, so as to mainly detect a film thickness abnormality that is generated after coating; an advantage is that an abnormality that occurs after coating may be found in time, and the abnormality may be processed and mura (mura of developing brightness) detected by the color film colorimeter may be confirmed in a subsequent process; and a disadvantage is that the detected abnormality may be a false abnormality.

In an embodiment of this application, macroscopic inspection is performed after the exposure machine and before developer, so as to mainly detect an abnormality that is generated after coating and exposure; an advantage is that the abnormality that occurs after coating and exposure may be found in time, and the abnormality may be processed and some false abnormalities may be eliminated in the subsequent process; and a disadvantage is that the macroscopic inspection does not well cooperate with the color film colorimeter,

In an embodiment of this application, macroscopic inspection is performed after developer and before oven, so as to mainly detect an abnormality that occurs after developing; an advantage is that the abnormality that occurs after developing may be found in time, and the abnormality may be subsequently processed; and a disadvantage is that the macroscopic inspection cannot cooperate with the color film colorimeter, a detection frequency and an interception capability are limited, and a process for processing an abnormal product is complex.

In an embodiment of this application, a macroscopic inspection machine is placed after an oven, and the CF is detected after all the processes are completed; an advantage is that the detection is accurate and a false abnormality can be excluded to a maximum limit; and a disadvantage is that subsequent processing cannot be performed after an abnormality is detected, and reworking needs to be performed. A great loss is caused when an abnormality occurs,

### BRIEF DESCRIPTION OF THE DRAWINGS

FIG. 1 is a tape-out method for a glass substrate to enter a glass substrate flowing device from the upstream according to an embodiment of this application: (1) entering a color film macroscopic inspection unit for inspection; (2) bypassing the color film macroscopic inspection unit and directly entering an exposure machine; and (3) bypassing the color film macroscopic inspection unit and the exposure machine, and directly flowing to the downstream;

FIG. 2 is a schematic diagram of performing macroscopic inspection after coater and before an exposure machine, and cooperating with a color film colorimeter device, so as to mainly detect a film thickness abnormality that is generated after coating according to an embodiment of this application;

FIG. 3 is a schematic diagram of performing macroscopic inspection after the exposure machine and before developer, so as to mainly detect an abnormality that is generated after coating and exposure according to an embodiment of this application;

FIG. 4 is a schematic diagram of performing macroscopic inspection after developer and before oven, so as to mainly detect an abnormality that occurs after developing according to an embodiment of this application;

FIG. 5 is a schematic diagram of placing a macroscopic inspection machine after an oven, to detect a CF after all processes are completed according to an embodiment of this application; and

FIG. 6A and FIG. 6B show that a shutter needs to be added to the color film macroscopic inspection unit, a shutter is added to an appropriate position above or below a shutter of an original transmission channel of a macroscopic inspection machine, and a platform height needs to be adjusted according to a unit sent by a signal on software so as to accept the glass substrate according to an embodiment of this application.

### DETAILED DESCRIPTION

The following embodiments are described with reference to the accompanying drawings, which are used to exemplify specific embodiments for implementation of this application. Terms about directions mentioned in this application, such as “on”, “below”, “front”, “back”, “left”, “right”, “inside”, “outside”, and “side surface” merely refer to directions in the accompanying drawings. Therefore, the used terms about directions are used to describe and understand this application, and are not intended to limit this application.

The accompanying drawings and the descriptions are considered to be essentially exemplary, rather than limitative. In the drawings, units with similar structures are represented by using a same numeral. In addition, for understanding and ease of description, a size and a thickness of each component shown in the accompanying drawings are arbitrarily shown, but this application is not limited thereto.

In the accompanying drawings, for clarity, thicknesses of a layer, a film, a panel, an area, and the like are enlarged. In the accompanying drawings, for understanding and ease of description, thicknesses of some layers and areas are enlarged. It should be understood that when a component, for example, a layer, a film, an area, or a substrate is described as “being located” “on” another component, the component may be directly on the another component, or there is a middle component.

In addition, in the specification, unless clearly described as an opposite meaning, a word “include” is understood as including the component but not excluding any other components. In addition, in the description, “being located on . . . ” indicates being located above or below a target component, but does not indicate having to be located on the top based on a gravity direction.

To further describe technical means used in this application for achieving a predetermined invention objective and effects of this application, with reference to the accompany drawings and preferred embodiments, the following describes in details embodiments, structures, features, and effects of a dynamic CF macroscopic inspection system and method that are provided in this application.

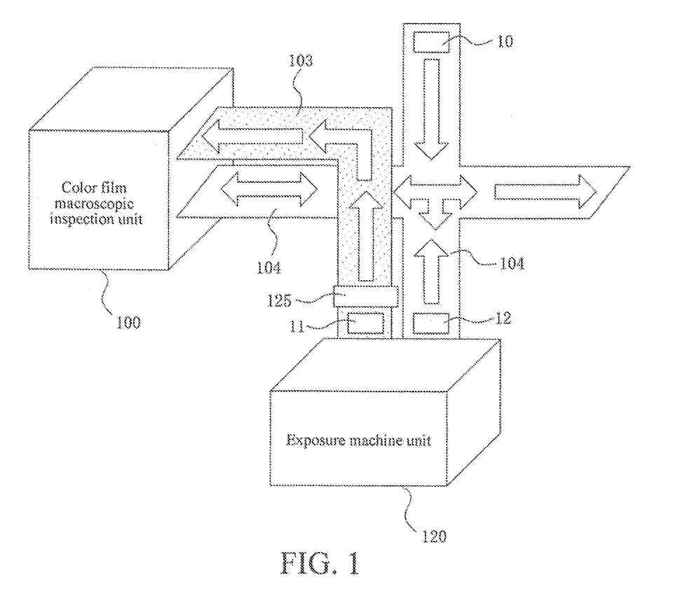

In FIG. 1, by means of a feature that a unit adjustment platform of a color film macroscopic inspection unit 100 is movable, a shutter is added based on a traditional single-shutter design of a macroscopic inspection machine, and an external conveying device used to convey a CF substrate is appropriately added. In combination with a glass substrate flowing design, a plurality of inspection applications of the color film macroscopic inspection unit 100 for a glass substrate before exposure and a glass substrate after exposure, in a combination with detection results of an exposure machine 120 and a color film colorimeter unit 130 may be implemented.

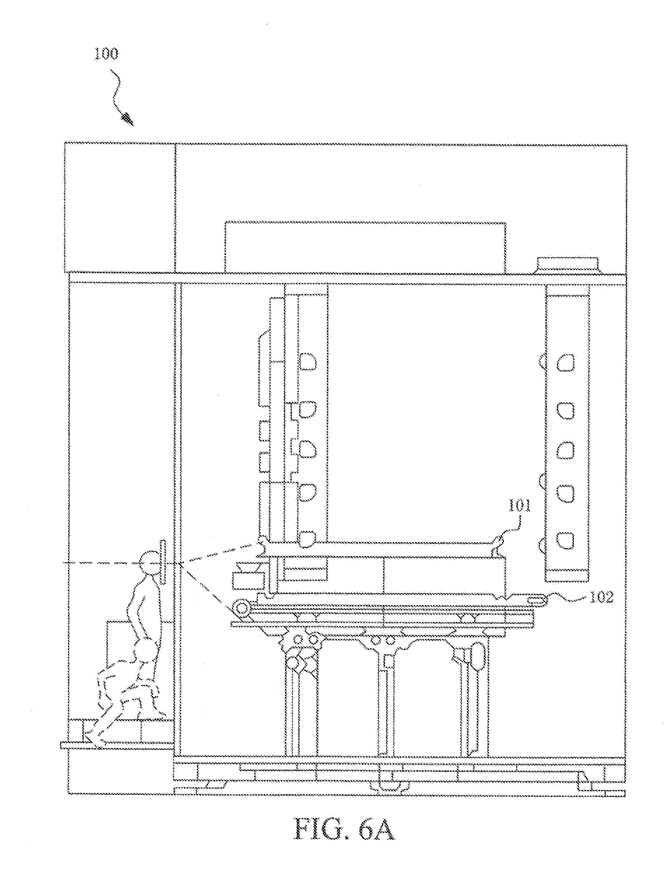

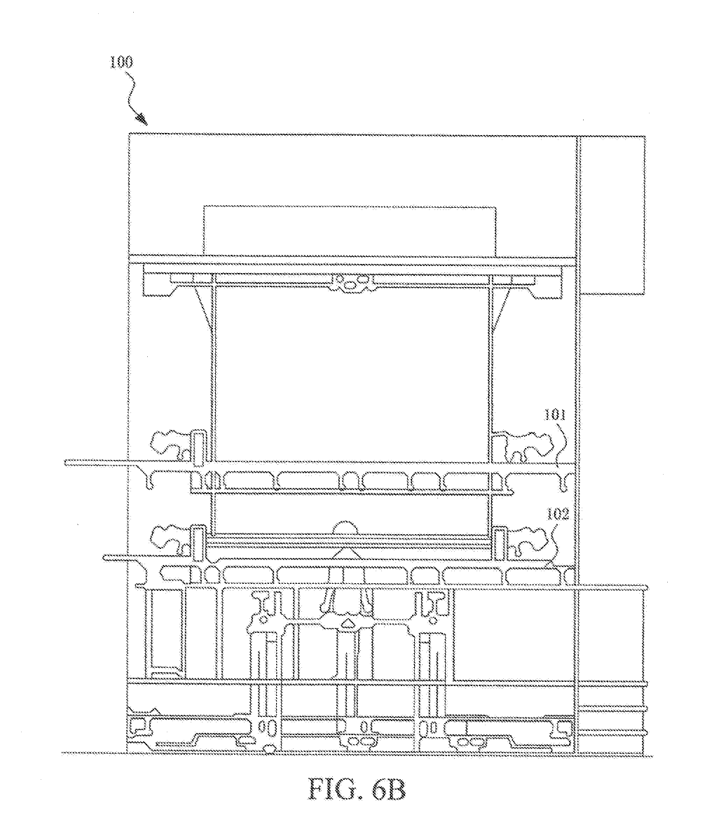

Referring to FIG. 1, FIG. 6A, and FIG. 6B, FIG. 1 is a tape-out method for a glass substrate to enter a glass substrate flowing device from the upstream according to an embodiment of this application: (1) entering a color film macroscopic inspection unit 100 for inspection; (2) bypassing the color film macroscopic inspection unit 100 and directly entering the exposure machine 120; and (3) bypassing the color film macroscopic inspection unit 100 and the exposure machine 120, and directly flowing to the downstream. FIG. 6A and FIG. 6B show that a shutter needs to be added to the color film macroscopic inspection unit 100, a shutter 102 is added to an appropriate position above or below a shutter 101 of an original transmission channel of the color film macroscopic inspection unit, and a platform height needs to be adjusted according to a unit sent by a signal on software so as to accept the glass substrate according to an embodiment of this application. In FIG. 1, there may be three tape-out methods for the glass substrate coming from the upstream: a. entering the color film macroscopic inspection unit 100 for inspection; b. bypassing the color film macroscopic inspection unit 100 and directly entering the exposure machine; and c. bypassing the color film macroscopic inspection unit 100 and the exposure machine 120, and directly flowing to the downstream.

FIG. 1, there are two tape-out methods after the glass substrate exits from the exposure machine 120: a. flowing to the downstream by means of a second conveyor belt 104; and b. passing through a first conveyor belt 103 and entering the color film macroscopic inspection unit 100 for inspection.

In FIG. 1, for the color film macroscopic inspection unit 100, a glass substrate that is not exposed or a glass substrate that is inspected and marked by the color film colorimeter unit 130 enters the color film macroscopic inspection unit 100 from the second conveyor belt 104; a glass substrate after exposure enters the color film macroscopic inspection unit 100 from the first conveyor belt 103, and the glass substrate leaves from the second conveyor belt 104.

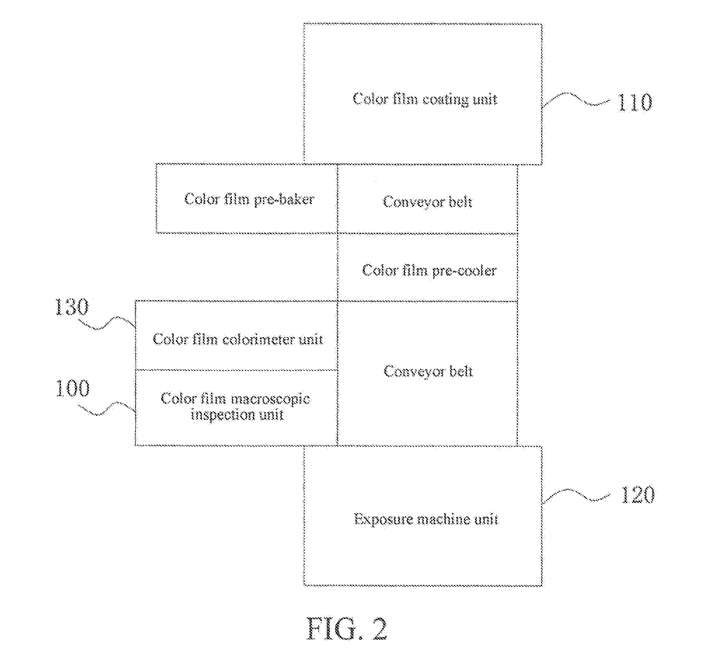

Referring to FIG. 2, FIG. 2 is a schematic diagram of performing macroscopic inspection after coater and before an exposure machine, and cooperating with a color film colorimeter unit, so as to mainly detect a film thickness abnormality that is generated after coating. In FIG, 2, the color film macroscopic inspection unit 100 is placed after a coater 110 and before the exposure machine 120, and cooperates with the color film colorimeter unit 130 so as to mainly detect a film thickness abnormality that is generated after coating. An abnormality that occurs after coating may be found in time, and the abnormality may be processed and mura (mura of developing brightness) detected by the color film colorimeter unit 130 may be confirmed in a subsequent process. A disadvantage is that the detected abnormality may be a false abnormality.

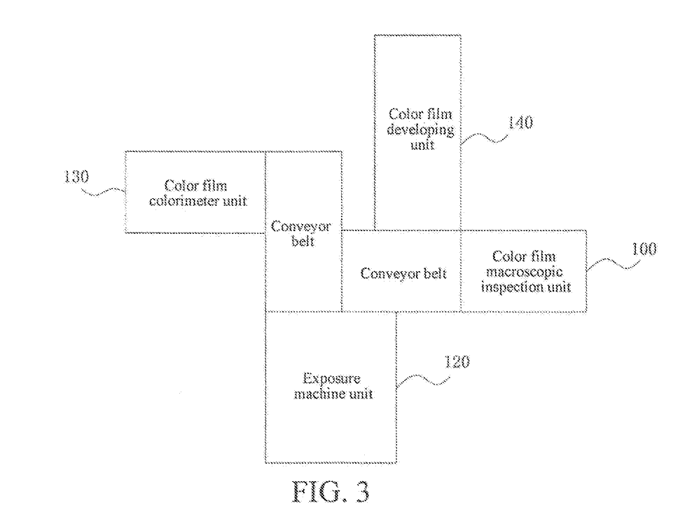

Referring to FIG. 3, FIG. 3 is a schematic diagram of performing macroscopic inspection after the exposure machine and before developer, so as to mainly detect an abnormality that is generated after coating and exposure. In FIG. 3, the color film macroscopic inspection unit 100 is placed after the exposure machine 120 and before a developer 140, so as to mainly detect an abnormality that is generated after coating and exposure. The abnormality that occurs after coating and exposure may be found in time, and the abnormality may be processed and some false abnormalities may be eliminated in the subsequent process. A disadvantage is that the color film macroscopic inspection unit does not well cooperate with the color film colorimeter unit 130.

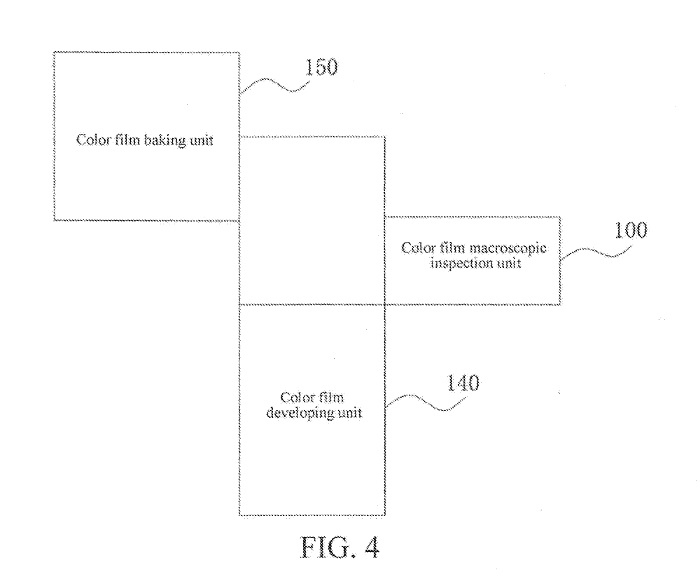

Referring to FIG. 4, FIG. 4 is a schematic diagram of performing macroscopic inspection after developer and before oven, so as to mainly detect an abnormality that occurs after developing. In FIG. 4, the color film macroscopic inspection unit 100 is placed after the developer 140 and before an oven 150, so as to mainly detect the abnormality that occurs after developing. The abnormality that occurs after developing may be found in time, and the abnormality may be subsequently processed. A disadvantage is that the color film macroscopic inspection unit cannot cooperate with the color film colorimeter unit 130, a detection frequency and an interception capability are limited, and a process for processing an abnormal product is complex.

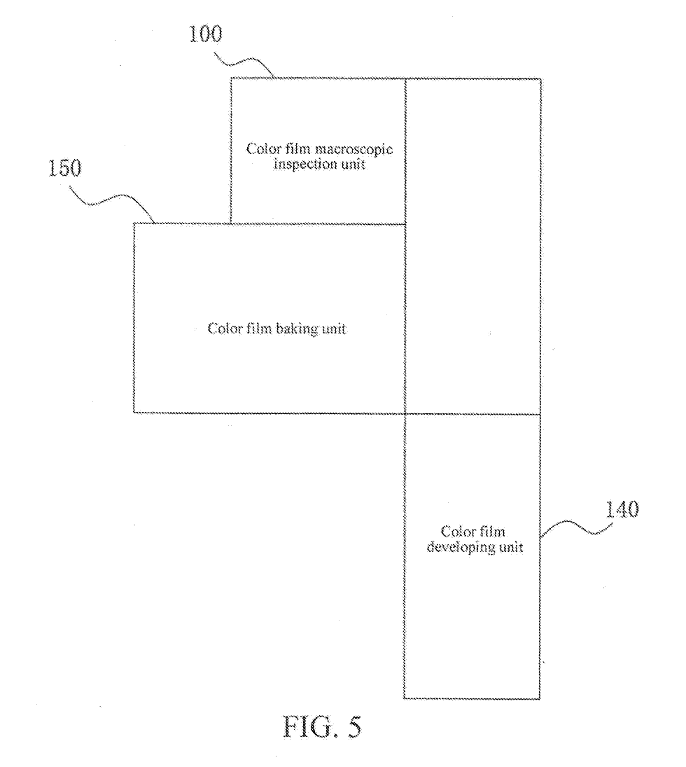

Referring to FIG. 5, FIG. 5 is a schematic diagram of placing a macroscopic inspection machine after an oven, to detect a CF after all processes are completed. In FIG. 5, the color film macroscopic inspection unit 100 is placed after the oven 150, to detect the CF after all the processes are completed. An advantage is that the detection is accurate and a false abnormality can be excluded to a maximum limit A disadvantage is that subsequent processing cannot be performed after an abnormality is detected, and reworking needs to be performed. A great loss is caused when an abnormality occurs.

Referring to FIG. 1 to FIG. 6A and FIG. 6B, a dynamic CF macroscopic inspection system includes: the color film coating unit 110, configured to coat color filters on a CF glass substrate 10; the color film developing unit 140, configured to develop the CF glass substrate 10; the color film baking unit 150, configured to bake the CF glass substrate 10; the color film macroscopic inspection unit 100, configured to inspect a visual macroscopic abnormality of the CF glass substrate 10; the color film colorimeter unit 130, configured to perform a chrominance detection on the CF glass substrate 10; the exposure machine unit 120, configured to expose the CF glass substrate 10; and at least one conveyor belt 103 and 104, connected between the color film coating unit 110, the color film developing unit 140, the color film baking unit 150, the color film macroscopic inspection unit 100, the exposure machine unit 120, and the color film colorimeter unit 130, and configured to transport the CF glass substrate 10.

In an embodiment, the conveyor belts 103 and 104 are adjusted to implement a plurality of inspection applications for the CF glass substrate 10 before exposure and the CF glass substrates 11 and 12 after exposure, in combination with a detection result of the color film colorimeter unit 130.

In an embodiment, the color film macroscopic inspection unit 100 further includes two shutters 101 and 102 for the CF glass substrate 10 to get in and out, and these shutters 101 and 102 are respectively connected to the first conveyor belt 103 and the second conveyor belt 104.

In an embodiment, the CF glass substrate 10 that is not exposed or the CF glass substrate 10 that is detected and marked by the color film colorimeter enters the color film macroscopic inspection unit 100 from the second conveyor belt 104.

In an embodiment, the CF glass substrate 11 after exposure enters the color film macroscopic inspection unit 100 from the first conveyor belt 103, and the CF glass substrate 12 leaves from the second conveyor belt 104.

Referring to FIG. 1 to FIG. 6A and FIG. 6B, a dynamic CF macroscopic inspection method includes: placing a CF glass substrate 10 on a conveyor belt; performing normal random inspection on the CF glass substrate 10 that passes through the color film coating unit 110; performing normal random inspection on the CF glass substrates 11 and 12 that pass through the exposure machine unit 120; cooperating with the color film colorimeter unit 130, and re-determining, an abnormal CF glass substrate detected by the color film colorimeter unit 130; and inspecting, in the color film macroscopic inspection unit 100, a foreign body detected by a color film protrusion inspection machine 125.

In an embodiment, the color film macroscopic inspection unit 100 further includes two shutters 101 and 102 for the CF glass substrate 10 to get in and out, and these shutters 101 and 102 are respectively connected to the first conveyor belt 103 and the second conveyor belt 104.

In an embodiment, the CF glass substrate 10 enters, from the second conveyor belt 104, the color film macroscopic inspection unit 100 for inspection.

In an embodiment, the CF glass substrate 10 bypasses the color film macroscopic inspection unit 100 and, directly enters the exposure machine unit 120.

In an embodiment the CF glass substrate 10 bypasses the color film macroscopic inspection unit 100 and the exposure machine unit 120.

In an embodiment, after passing through the exposure machine unit 120, the CF glass substrate 11 enters, from the second conveyor belt 103, the color film macroscopic inspection unit 100 for inspection.

In an embodiment of this application, the CF glass substrate 12 leaves from the second, conveyor belt 104 after passing through the exposure machine unit 120.

Phrases such as “in some embodiments” and “in various embodiments” are repeatedly used. The phrases usually do not refer to same embodiments, but the phrases may refer to same embodiments. Words like “contain”, “have”, and “include” are synonyms, unless other meanings are indicated in the context of the words.

The foregoing descriptions are merely preferred embodiments of this application, and are not intended to limit this application in any form. Although this application has been disclosed above through the preferred embodiments, the embodiments are not intended to limit this application. Any person skilled in the art can make some equivalent variations or modifications according to the foregoing disclosed technical content without departing from the scope of the technical solutions of this application to obtain equivalent embodiments. Any simple amendment, equivalent change, or modification made to the foregoing embodiments according to the technical essence of this application without departing from the content of the technical solutions of this application shall fall within the scope of the technical solutions of this application.

What is claimed is:

1. A dynamic color filter (CF) macroscopic inspection system, comprising:
a color film coating unit, configured to coat color filters on a CF glass substrate;
a color film developing unit, configured to develop the CF glass substrate;
a color film baking unit, configured to bake the CF glass substrate;
a color film macroscopic inspection unit, configured to inspect a visual macroscopic abnormality of the CF glass substrate;
a color film colorimeter unit, configured to perform a chrominance detection on the CF glass substrate; and
at least one conveyor belt, comprising a first conveyor belt and a second conveyor belt, connected between the color film coating unit, the color film developing unit, the color film baking unit, the color film macroscopic inspection unit, and the color film colorimeter unit, and configured to transport the CF glass substrate.

2. The dynamic CF macroscopic inspection system according to claim 1, further comprising: an exposure machine unit, connected to the conveyor belt and configured to expose the CF glass substrate.

3. The dynamic CF macroscopic inspection system according to claim 1, wherein the conveyor belt is adjusted to implement a plurality of inspection applications for the CF glass substrate before exposure and the CF glass substrate after exposure, in combination with a detection result of the color film colorimeter unit.

4. The dynamic CF macroscopic inspection system according to claim 1, wherein the color film macroscopic inspection unit further comprises two shutters for the CF glass substrate to get in and out, and these shutters are respectively connected to the first conveyor belt and the second conveyor belt.

5. The dynamic CF macroscopic inspection system according to claim 1, wherein the CF glass substrate that is not exposed or the CF glass substrate that is detected and marked by the color film colorimeter enters the color film macroscopic inspection unit from the second conveyor belt.

6. The dynamic CF macroscopic inspection system according to claim 1, wherein the CF glass substrate after exposure enters the color film macroscopic inspection unit from the first conveyor belt, and, the CF glass substrate leaves from the second conveyor belt.

7. A dynamic color filter (CF) macroscopic inspection method, comprising:
placing a CF glass substrate on, a conveyor belt;
performing normal random inspection on the CF glass substrate that passes through a color film coating unit;
performing normal random inspection on the CF glass substrate that passes through an exposure machine unit;
cooperating with a color film colorimeter unit, and re-determining an abnormal CF glass substrate detected by the color film colorimeter unit; and
inspecting, in a color film macroscopic inspection unit, a foreign body detected by a color film protrusion inspection machine, wherein
the conveyor belt comprises a first conveyor belt and a second conveyor belt and is configured to transport the CF glass substrate.

8. The dynamic CF macroscopic inspection method according to claim 7, wherein the CF glass substrate enters, from the second conveyor belt, the color film macroscopic inspection unit for inspection.

9. The dynamic CF macroscopic inspection method according to claim 7, wherein the CF glass substrate bypasses the color film macroscopic inspection unit and directly enters the exposure machine unit.

10. The dynamic CF macroscopic inspection method according to claim 7, wherein the CF glass substrate bypasses the color film macroscopic inspection unit and the exposure machine unit.

11. The dynamic CF macroscopic inspection method according to claim 7, wherein the CF glass substrate enters, from the first conveyor belt after passing through the exposure machine unit, the color film macroscopic inspection unit for inspection.

12. The dynamic CF macroscopic inspection method according to claim 7, wherein the CF glass substrate leaves from the second conveyor belt after passing through the exposure machine unit.

13. The dynamic CF macroscopic inspection method according to claim 7, wherein the conveyor belt is adjusted to implement a plurality of inspection applications for the CF glass substrate before exposure and the CF glass substrate after exposure, in combination with a detection result of the color film colorimeter unit.

14. The dynamic CF macroscopic inspection method according to claim wherein the color film macroscopic inspection unit further comprises two shutters for the CF glass substrate to get in and out, and these shutters are respectively connected to the first conveyor belt and the second conveyor belt.

15. A dynamic color filter (CF) macroscopic inspection system, comprising:
a color film coating unit, configured to coat color filters on a CF glass substrate;
a color film developing unit, configured to develop the CF glass substrate;
a color film baking unit, configured to bake the CF glass substrate;
a color film macroscopic inspection unit, configured to inspect a visual macroscopic abnormality of the CF glass substrate;
a color film colorimeter unit, configured to perform a chrominance detection on the CF glass substrate;
an exposure machine unit, configured to expose the CF glass substrate; and
at least one conveyor belt, comprising a first conveyor belt and a second conveyor belt, connected between the color film coating unit, the color film developing unit, the color film baking unit, the color film macroscopic inspection unit, the exposure machine unit, and the color film colorimeter unit, and configured to transport the CF glass substrate, wherein
the color film macroscopic inspection unit further comprises two shutters for the CF glass substrate to get in and out, and these shutters are respectively connected to the first conveyor belt and the second conveyor belt;
the CF glass substrate that is not exposed or the CF glass substrate that is detected and marked by the color film colorimeter enters the color film macroscopic inspection unit from the second conveyor belt;
the CF glass substrate after exposure enters the color film macroscopic inspection unit from the first conveyor belt, and the CF glass substrate leaves from the second conveyor belt;
the conveyor belt is adjusted to implement a plurality of inspection applications for the CF glass substrate before exposure and the CF glass substrate after exposure, in combination with a detection result of the color film colorimeter unit; and
a unit adjustment platform of the color film macroscopic inspection unit is a movable platform.
